(19) United States
(12) Patent Application Publication
(10) Pub. No.: US 2022/0188733 A1
(43) Pub. Date: Jun. 16, 2022

(54) SYSTEMS AND METHODS FOR REVIEWING PERFORMANCE OF COMPUTER MODELS FOR SAFETY ANALYSIS IN TRANSPORTATION SERVICES

(71) Applicant: Beijing DiDi Infinity Technology and Development Co., Ltd., Beijing (CN)

(72) Inventors: Wei Wang, Sunnyvale, CA (US); Conghui Fu, Sunnyvale, CA (US); Zihan Yi, Mountain View, CA (US); Xin Chen, Sunnyvale, CA (US); Zhonglin Lian, Beijing (CN); Zhilong Wang, Cupertino, CA (US)

(73) Assignee: Beijing DiDi Infinity Technology and Development Co., Ltd., Beijing (CN)

(21) Appl. No.: 17/124,445

(22) Filed: Dec. 16, 2020

(51) Int. Cl. G06Q 10/06; G06Q 50/30; G06Q 50/26; G06Q 10/10; G06N 5/04; G06N 20/00

(52) U.S. Cl. CPC G06Q 10/06395; G06Q 50/30; G06Q 50/265; G06N 20/00; G06Q 10/0635; G06N 5/04; G06Q 10/10

(57) ABSTRACT

Embodiments of the disclosure provide systems and methods for reviewing performance of computer models for safety analysis in transportation services. The exemplary system includes a communication interface configured to receive log data associated with at least one reported safety event. The log data includes one or more computer models used for predicting the reported safety event and associated with a first feature pattern and a first model performance. The system further includes at least one processor configured to extract features from the log data and determine a second feature pattern and a second model performance of the computer models. The at least one processor is also configured to detect a change in feature pattern based on the first feature pattern and the second feature pattern or a performance degradation based on the first model performance and the second model performance, and to generate an alert to upgrade the computer models.

### TECHNICAL FIELD

The present disclosure relates to systems and methods for reviewing performance of computer models, and more particularly to, reviewing performance of computer models for safety analysis in transportation services.

### BACKGROUND

An online ride-hailing platform (e.g., DiDi™ online) can receive a rideshare service request from a passenger and then route the service request to at least one transportation service provider (e.g., a taxi driver, a private car owner, or the like). After the transportation service request is answered by the driver, the driver will pick up the passenger, and drive the passenger to the requested destination. The driver and the passenger otherwise do not know each other prior to the rideshare service. Sometimes, a driver may commit a crime spontaneously to the passenger, such as a sexual harassment. Sometimes, a person may disguise himself as the passenger to request a transportation service in order to commit crimes against the driver, such as robbery, assault, or battery. For example, the disguised passenger may rob the driver either during the trip or at the destination.

To prevent the crime from happening, the ride-hailing platform may use multiple computer models to analyze service-related data and predict potential safety events prior to the rideshare service and/or during the service. For example, some computer models are used to estimate a passenger risk level based on the passenger data such as a quantity of trips completed by the passenger, a cancellation rate of the passenger, etc. Some computer models focus on estimating a trip risk based on the order data such as a remoteness of the destination, a pickup time, etc. To maintain high performance of the computer models, an operator may periodically review prediction results made by the computer models for predicting reported safety events. If the performance of the computer model degrades, the operator may update parameters of the computer model. However, as computer models are more frequently used for predicting the reported safety events, manually reviewing performance of each computer model and updating the model parameters based on the reported safety events become time consuming and impractical.

Embodiments of the disclosure solve the above-mentioned issues by providing systems and methods for reviewing performance of computer models for safety analysis in transportation services.

### SUMMARY

Embodiments of the disclosure provide a system for reviewing performance of computer models for safety analysis in transportation services. The exemplary system includes a communication interface configured to receive log data associated with at least one reported safety event. The log data includes information of the reported safety event, a transportation service during which the reported safety event occurs, and one or more computer models used for predicting the reported safety event. The one or more computer models are associated with a first feature pattern and a first model performance. The exemplary system further includes at least one processor. The at least one processor is configured to extract a plurality of features from the log data that are used by the computer models to make a safety prediction. The at least one processor is further configured to determine a second feature pattern indicative of respective impacts of the features on the safety prediction result made by the computer models. The at least one processor is also configured to determine a second model performance of the computer models based on the safety prediction made by the computer models compared with the reported safety event. The at least one processor is additionally configured to detect a change in feature pattern based on the first feature pattern and the second feature pattern or a performance degradation based on the first model performance and the second model performance. The at least one processor is also configured to generate an alert to upgrade the computer models.

Embodiments of the disclosure also provide a method for reviewing performance of computer models for safety analysis in transportation services. The exemplary method includes receiving, by a communication interface, log data associated with at least one reported safety event. The log data includes information of the reported safety event, a transportation service during which the reported safety event occurs, and one or more computer models used for predicting the reported safety event. The one or more computer models are associated with a first feature pattern and a first model performance. The method further includes extracting, by at least one processor, a plurality of features from the log data that are used by the computer models to make a safety prediction. The method also includes determining, by the at least one processor, a second feature pattern indicative of respective impacts of the features on the safety prediction result made by the computer models. The method additionally includes determining, by the at least one processor, a second model performance of the computer models based on the safety prediction made by the computer models compared with the reported safety event. The method further includes detecting a change in feature pattern based on the first feature pattern and the second feature pattern or a performance degradation based on the first model performance and the second model performance. The method also includes generating, by the at least one processor, an alert to upgrade the computer models.

Embodiments of the disclosure further provide a non-transitory computer-readable medium having instructions stored thereon that, when executed by at least one processor, causes the at least one processor to perform a method for reviewing performance of computer models for safety analysis in transportation services. An exemplary method includes receiving log data associated with at least one reported safety event. The log data includes information of the reported safety event, a transportation service during which the reported safety event occurs, and one or more computer models used for predicting the reported safety event. The one or more computer models are associated with a first feature pattern and a first model performance. The method further includes extracting a plurality of features from the log data that are used by the computer models to make a safety prediction. The method also includes determining a second feature pattern indicative of respective impacts of the features on the safety prediction result made by the computer models. The method additionally includes determining a second model performance of the computer models based on the safety prediction made by the computer models compared with the reported safety event. The method further includes detecting a change in feature pattern based on the first feature pattern and the second feature pattern or a performance degradation based on the first model performance and the second model performance. The method also includes generating an alert to upgrade the computer models.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary model review system, according to embodiments of the disclosure.

FIG. 2 illustrates a block diagram of an exemplary model review device, according to embodiments of the disclosure.

FIG. 3 illustrates a data flow diagram of an exemplary model review device illustrated in FIG. 1, according to embodiments of the disclosure.

FIG. 4 is a flowchart of an exemplary method for reviewing computer models, according to embodiments of the disclosure.

FIG. 5 illustrates a data flow diagram of an exemplary method for generating a model review report for a reported safety event, according to embodiments of the disclosure.

FIG. 6 illustrates an exemplary plot for displaying feature impacts on a safety prediction, according to embodiments of the disclosure.

FIG. 7 is a flowchart of an exemplary method for generating a model review report for a reported safety event, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The disclosed systems and methods review performance of computer models for safety analysis in transportation services based on log data. In some embodiments, the computer models for predicting rideshare safety events include machine learning models and rule-based models. For example, the computer models may include driver risk prediction models, passenger risk prediction models, geo-location risk prediction models, relationship graph analysis models, and the like. In some embodiments, the log data may include information of reported safety events, information of transportation services associated with the reported safety events, and computer models used for predicting the reported safety events.

In some embodiments, features may be extracted from the log data which are used by the computer models for predicting the reported safety events. A feature pattern (e.g., data distribution) of the extracted features may be determined and compared with an existing feature pattern associated with the computer models. In some embodiments, the existing feature pattern may be a feature pattern of the features extracted from training data used for training the computer models. In some embodiments, the existing feature pattern may be previous feature pattern of the features extracted from a previous set of log data. If the two feature patterns are different, an alert may be generated for upgrading the computer models.

In some embodiments, safety predictions made by the computer models may be obtained from the log data. A model performance may further be determined based on the safety prediction and the reported safety event. The determined model performance may also be compared with a previous model performance determined based on a previous set of log data. If the determined model performance is lower than the previous model performance based on the previous set of log data, an alert may be generated for upgrading the computer models.

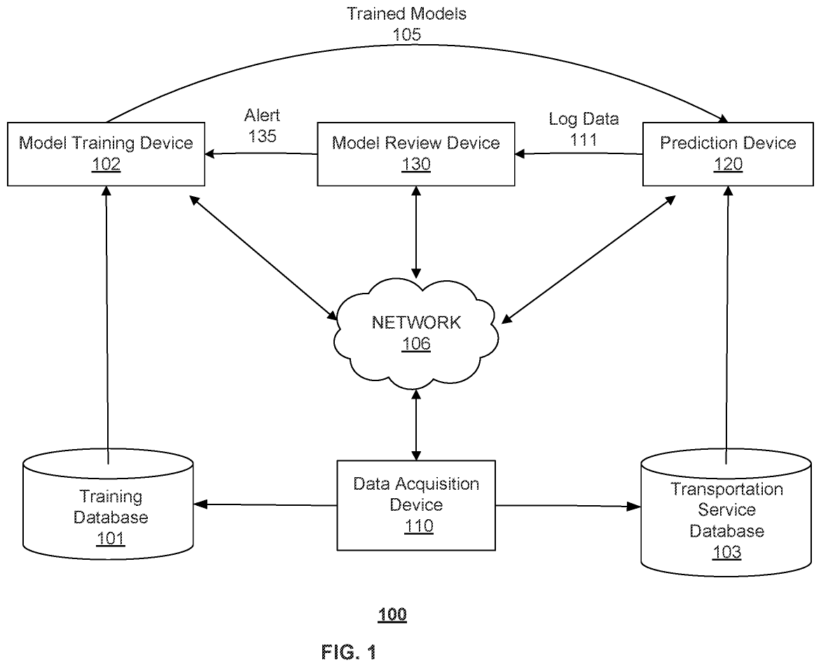

FIG. 1 illustrates an exemplary model review system 100 (referred to as “system 100” hereafter), according to embodiments of the disclosure. In some embodiments, system 100 may be configured to review performance of the computer models for safety analysis in transportation services. As shown in FIG. 1, system 100 may include components for performing three phases, a training phase, a prediction phase, and a review phase. To perform the training phase, system 100 may include a training database 101 and a model training device 102. To perform the prediction phase, system 100 may include a prediction device 120 and a transportation service database 103. To perform the review phase, system 100 may include a model review device 130. In some embodiments, system 100 may include more or less of the components shown in FIG. 1. For example, when the log data for reviewing performance of computer models are provided, system 100 may include only model review device 130, model training device 102, and training database 101.

In some embodiments, system 100 may optionally include a network 106 to facilitate the communication among the various components of system 100, such as training database 101, model training device 102, prediction device 120, model review device 130, and one or more data acquisition device 110. For example, network 106 may be a local area network (LAN), a wireless network, a cloud computing environment (e.g., software as a service, platform as a service, infrastructure as a service), a client-server, a wide area network (WAN), etc. In some embodiments, network 106 may be replaced by wired data communication systems or devices.

In some embodiments, the various components of system 100 may be remote from each other or in different locations, and be connected through network 106 as shown in FIG. 1. In some alternative embodiments, certain components of system 100 may be located on the same site or inside one device. For example, training database 101 may be located on-site with or be part of model training device 102. As another example, model training device 102 and prediction device 120 may be inside the same computer or processing device.

As shown in FIG. 1, model training device 102 may communicate with training database 101 to receive one or more sets of training data. Model training device 102 may use the training data received from training database 101 to train a plurality of computer models (e.g., trained models 105). Trained models 105 may include machine learning models and rule-based models for predicting safety events occurring during the rideshare services. For example, model training device 102 may train a first computer model to determine a passenger risk based on passenger training data (e.g., a quantity of completed trips, a cancellation rate, and a quantity of user accounts associated with a same contact method). In the example, model training device 102 may further train a second computer model to predict a risk of the transportation service based on the passenger risk determined using the first computer model and the information of the transportation service.

In some embodiments, the training phase may be performed “online” or “offline.” An “online” training refers to performing the training phase contemporarily with the prediction phase, e.g., learning the models in real-time just prior to predicting a risk based on a service request. An “online” training may have the benefit to obtain a most updated computer model based on the training data that is then available. However, an “online” training may be computational costive to perform and may not always be possible if the training data is large and/or the models are complicate. Consistent with the present disclosure, an “offline” training is used where the training phase is performed separately from the prediction phase. The learned models trained offline are saved and reused for predicting safety events.

Model training device 102 may be implemented with hardware specially programmed by software that performs the training process. For example, model training device 102 may include a processor and a non-transitory computer-readable medium. The processor may conduct the training by performing instructions of a training process stored in the computer-readable medium. Model training device 102 may additionally include input and output interfaces to communicate with training database 101, network 106, and/or a user interface (not shown). The user interface may be used for selecting sets of training data, adjusting one or more parameters of the training process, selecting or modifying a framework of the machine learning models, and/or manually or semi-automatically providing ground-truth associated with the training data. In some embodiments, the user interface may further receive an alert (e.g., alert 135) from model review device 130 to upgrade trained models 105.

Trained models 105 may be used by prediction device 120 to predict the safety events based on the transportation service data that is not associated with a ground-truth. Prediction device 120 may receive trained models 105 from model training device 102 and transportation service data from transportation service database 103. Prediction device 120 may include a processor and a non-transitory computer-readable medium. The processor may perform instructions of a sequence of processes stored in the medium for predicting the safety events. Prediction device 120 may additionally include input and output interfaces to communicate with a transportation service database 103, network 106, model review device 130, and/or a user interface (not shown). The user interface may be used for receiving one or more sets of service data from transportation service database 103, initiating the prediction process, and sending data (e.g., log data 111) associated with the reported safety events to model review device 130 for review. Consistent with the present disclosure, log data 111 may include the information of the reported safety events, the information of the transportation services associated with the reported safety events, and computer models used for predicting the reported safety events.

Transportation service database 103 and training database 101 may communicate with data acquisition device 110 to receive one or more sets of service data including passenger information, driver information, service order information, etc. In some embodiments, data acquisition device 110 may be a mobile phone, a wearable device, a PDA, etc. used by the user (e.g., the passenger) to make a transportation service request. In some alternative embodiments, data acquisition device 110 may be used by a new user (e.g., a new passenger or a new driver) to register a user account for requesting or providing a rideshare service.

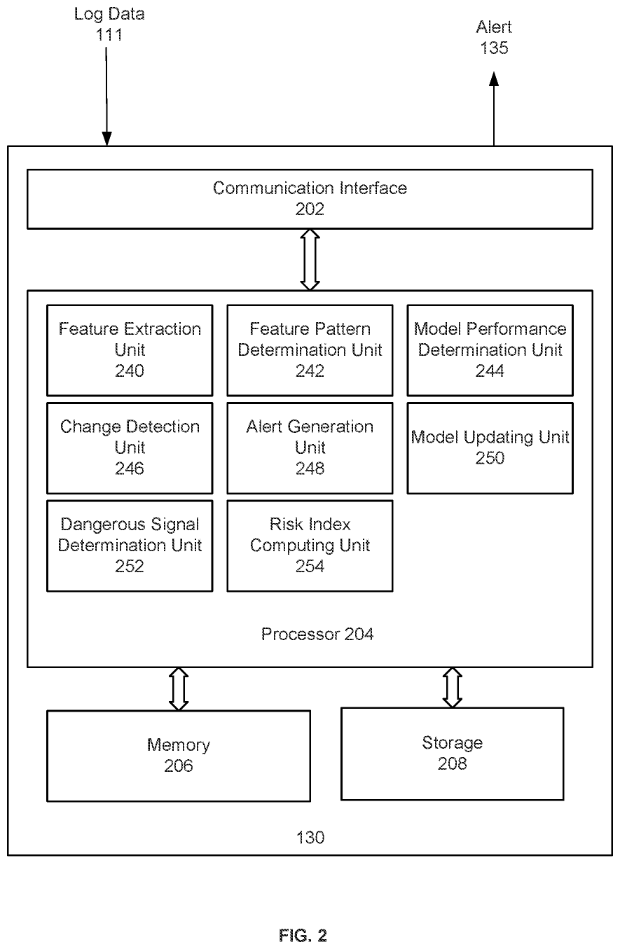

In some embodiments, model review device 130 may receive log data 111 from prediction device 120. Model review device 130 may include a processor and a non-transitory computer-readable medium (discussed in detail in connection with FIG. 2). The processor may perform instructions of a sequence of processes stored in the medium for reviewing performance of the computer models (e.g., trained models 105). Model review device 130 may additionally include input and output interfaces to communicate with model training device 102, prediction device 120, network 106, and/or a user interface (not shown). The user interface may be used for receiving one or more sets of log data from prediction device 120, initiating the review process, sending alert 135 to model training device 102 to upgrade the computer models. Model review device 130 may perform one or more of: (1) extracting features from the log data that are used by the computer models for predicting the safety events, (2) determining a feature pattern based on the extracted features, (3) determining a model performance of the computer models based on the safety predictions and the reported safety events, (4) detecting a change in the determined feature pattern or a model performance degradation, (5) generating an alert to upgrade the computer models, and (6) upgrading the computer models.

For example, FIG. 2 illustrates a block diagram of an exemplary model review device 130, according to embodiments of the disclosure. As shown in FIG. 2, model review device 130 may include a communication interface 202, a processor 204, a memory 206, and a storage 208. In some embodiments, model review device 130 may include different modules in a single device, such as an integrated circuit (IC) chip (implemented as an application-specific integrated circuit (ASIC) or a field-programmable gate array (FPGA)), or separate devices with dedicated functions. In some embodiments, one or more components of model review device 130 may be located in a cloud, or may be alternatively in a single location (such as a mobile device) or distributed locations. Components of model review device 130 may be in an integrated device, or distributed at different locations but communicate with each other through a network (not shown).

Communication interface 202 may send data to and receive data from components such as model training device 102 and prediction device 120 via communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 202 can be an integrated services digital network (ISDN) card, cable modem, satellite modem, or a modem to provide a data communication connection. As another example, communication interface 202 can be a local area network (LAN) card to provide a data communication connection to a compatible LAN. Wireless links can also be implemented by communication interface 202. In such an implementation, communication interface 202 can send and receive electrical, electromagnetic or optical signals that carry digital data streams representing various types of information via a network.

Consistent with some embodiments, communication interface 202 may receive log data 111 from prediction device 120. In some embodiments, communication interface 202 may further receive trained models 105 from model training device 102. Communication interface 202 may further provide the received data to storage 208 for storage or to processor 204 for processing. Communication interface 202 may send alert 135 to model training device 102 for updating the computer models.

Processor 204 may be a processing device that includes one or more general processing devices, such as a microprocessor, a central processing unit (CPU), a graphics processing unit (GPU), and the like. More specifically, processor 204 may be a complex instruction set computing (CISC) microprocessor, a reduced instruction set computing (RISC) microprocessor, a very long instruction word (VLIW) microprocessor, a processor running other instruction sets, or a processor that runs a combination of instruction sets. Processor 204 may also be one or more dedicated processing devices such as application specific integrated circuits (ASICs), field programmable gate arrays (FPGAs), digital signal processors (DSPs), system-on-chip (SoCs), and the like.

Processor 204 may be configured as a separate processor module dedicated to performing performance review of the computer models based on received log data 111. Alternatively, processor 204 may be configured as a shared processor module for performing other functions. Processor 204 may be communicatively coupled to memory 206 and/or storage 208 and configured to execute the computer-executable instructions stored thereon.

Memory 206 and storage 208 may include any appropriate type of mass storage provided to store any type of information that processor 204 may need to operate. Memory 206 and storage 208 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 206 and/or storage 208 may be configured to store one or more computer programs that may be executed by processor 204 to perform the model review disclosed herein. For example, memory 206 and/or storage 208 may be configured to store program(s) that may be executed by processor 204 to extract features, determine feature patterns, determine model performance, detect a change in feature patterns or a model performance degradation, and generate an upgrade alert to model training device 102 to upgrade the models. In some embodiments, memory 206 and/or storage 208 may also store program that can be executed to upgrade the models.

Memory 206 and/or storage 208 may be further configured to store information and data used by processor 204. For instance, memory 206 and/or storage 208 may be configured to store the various types of data such as features used by the computer models to make a prediction and data related to determining the model performance (e.g., safety predictions). Memory 206 and/or storage 208 may also store intermediate data such as the determined feature patterns and the determined model performance. Memory 206 and/or storage 208 may further store the feature patterns and the model performance determined based on previous set of log data used by processor 204. The various types of data may be stored permanently, removed periodically, or disregarded immediately after each frame of data is processed.

As shown in FIG. 2, processor 204 includes multiple modules, such as a feature extraction unit 240, a feature pattern determination unit 242, a model performance determination unit 244, a change detection unit 246, an alert generation unit 248, a model updating unit 250, a dangerous signal determination unit 252, a risk index computing unit 254, and the like. These modules (and any corresponding sub-modules or sub-units) can be hardware units (e.g., portions of an integrated circuit) of processor 204 designed for use with other components or software units implemented by processor 204 through executing at least part of a program. The program may be stored on a computer-readable medium, and when executed by processor 204, it may perform one or more functions. Although FIG. 2 shows units 240-254 all within one processor 204, it is contemplated that these units may be distributed among multiple processors located near or remotely with each other.

In some embodiments, units 240-254 of FIG. 2 may execute computer instructions to perform model performance review for predicting the safety events. In some embodiments, feature extraction unit 240 is configured to extract the features from the log data. The features are those used by the computer models to predict the safety events. In some embodiments, feature pattern determination unit 242 is configured to compute a data distribution of each extracted feature. In some embodiments, model performance determination unit 244 is configured to determine a model performance. For example, model performance determination unit 244 may compare the safety prediction made by the computer models with the reported safety event. If the predicted safety events align with those actually reported safety events, the model performance is rated higher. In some embodiments, change detection unit 246 is configured to detect a change in the feature patterns or a degradation of the model performance. In some embodiments, alert generation unit 248 is configured to generate an alert to upgrade the computer models when a change in the feature patterns or a degradation of the model performance is detected by change detection unit 246. In some embodiments, model updating unit 250 is configured to upgrade the computer models based on the upgrade alert generated by alert generation unit 248. In some alternative embodiments, the upgrade alert may be sent to model training device 102, which will upgrade the computer models. In some embodiments, dangerous signal determination unit 252 is configured to determine service information that is associated with a high risk of a safety event. In some embodiments, risk index computing unit 254 is configured to compute a risk index indicative of a risk level or a risk percentile of the driver, the passenger, or the transportation service.

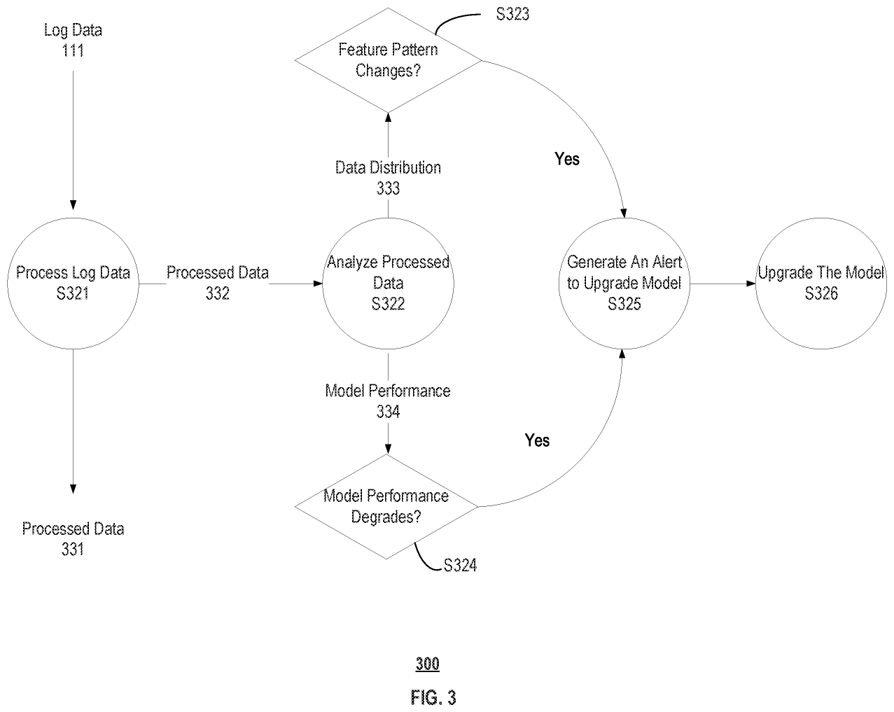

FIG. 3 illustrates a data flow diagram of an exemplary model review device 130 illustrated in FIG. 1, according to embodiments of the disclosure. As shown in FIG. 3, model review device 130 receives log data 111 from prediction device 120 or other data resources (not shown). Consistent with the present disclosure, log data 111 may include information of the reported safety event (e.g., robbery, assault, battery, sexual assault, or the like incidents) that occurs during the transportation service. For example, the information of the reported safety event may include a case number of the incident, a date of the incident, a crime type of the incident, a severity of the incident, a victim (e.g., the driver or the passenger), an aggressor (e.g., the passenger or the driver), an incident location, etc. Consistent with some embodiments, log data 111 may further include information of the transportation service during which the reported safety event occurs. For example, the information of the transportation service may include service order information (e.g., pickup time, pickup location, remoteness score of the destination, service duration, and payment method), the driver information (e.g., driver's name, a quantity of completed orders by the driver, driver's cancellation rate, and driver's phone number), and the passenger information (e.g., passenger's name, a quantity of completed orders by the passenger, passenger's cancellation rate, and passenger's phone number). In some embodiments, log data 111 may also include one or more computer models used for predicting the reported safety event. Consistent with some embodiments, the computer models may include the driver risk prediction models, the passenger risk prediction models, the geo-location risk prediction models, the relationship graph analysis models, models for predicting a specific crime (e.g., sexual assault), and the like.

In some embodiments, model review device 130 may be configured to process log data 111 in step S321 and generate processed data 331 and 332 as shown in FIG. 3. For example, feature extraction unit 240 of model review device 130 may be configured to extract features from log data 111 in step S321. Consistent with some embodiments, the features may be used by the computer models for predicting the reported safety events. For example, the features may include the information of the reported safety event (e.g., the crime type), the information of the service order information (e.g., the pickup location), the models used for predicting the safety event (e.g., a model for predicting sexual assaults), and the safety prediction (e.g., a driver risk score). In some embodiments, processed data 331 (e.g., the extracted features) may be saved in a criminal database (not shown). For example, the extracted features stored in the criminal database may be used for updating parameters of the computer models.

In some embodiments, model review device 130 may be configured to analyze processed data 332 in step S322. In some embodiments, feature pattern determination unit 242 of model review device 130 may be configured to compute a data distribution of the extracted features. For example, feature pattern determination unit 242 may compute a distribution of pickup times of the completed transportation services associated with the reported safety events. The transportation services are completed within a predetermined time window (e.g., one day or one week). Feature pattern determination unit 242 may further send the computed distribution information (e.g., data distribution 333) to change detection unit 246 for a further processing.

In some embodiments, model performance determination unit 244 of model review device 130 may be configured to analyze the safety prediction of the computer models. For example, model performance determination unit 244 may compute a risk level or a risk percentile of the transportation service using one or more computer models. Model performance determination unit 244 may further compare the computed risk level or risk percentile with the information of the reported safety events and determine the performance of the computer models. For example, the model performance is higher when the computed risk level or risk percentile is high for a safety event that later actually occurs. Model performance determination unit 244 may further send the determined model performance (e.g., model performance 334) to change detection unit 246 for further processing.

As shown in FIG. 3, in step S323, change detection unit 246 of model review device 130 may be configured to determine whether data distribution 333 is different with a data distribution of the same feature in the training data. For example, feature pattern determination unit 242 may determine a data distribution of pickup times in the log data, and change detection unit 246 may compare the computed data distribution (e.g., data distribution 333) with a distribution of pickup times in the training data. In some embodiments, instead of comparing with the feature pattern derived from the training data, data distribution 333 may be compared with a feature pattern (e.g., data distribution of the same feature) in a previous set of log data. If the two distributions are different with each other (step S323: Yes), alert generation unit 248 of model review device 130 is configured to generate an upgrade alert for upgrading the computer models in step S325. In some embodiments, the computer models may be upgraded by training new parameters of the computer model based on updated training data.

In some embodiments, in step S324, change detection unit 246 of model review device 130 may further be configured to determine whether the model performance (e.g., model performance 334) degrades. For example, model performance determination unit 244 may determine that a sexual assault prediction model obtains an accuracy of 80% for predicting the sexual assaults reported in a month. However, the prediction model obtains an accuracy of 90% for predicting the sexual assaults reported in a previous month. That is, the model performance degrades because the prediction accuracy on predicting the reported safety events in the month is lower than that in the previous month. If the model performance degrades (step S324: Yes), alert generation unit 248 of model review device 130 is configured to generate an upgrade alert for training new parameters of the corresponding computer model.

In some embodiments, model updating unit 250 of model review device 130 may be configured to update the computer model based on the generated alert in step S326. In some embodiments, model updating unit 250 may train the corresponding computer model which experiences a performance degradation on predicting the reported safety events. In some embodiments, model updating unit 250 may be configured to use data associated with the reported safety events to train new model parameters. In some alternative embodiments, the upgrade alert may be sent to model training device 102, which will upgrade the computer models.

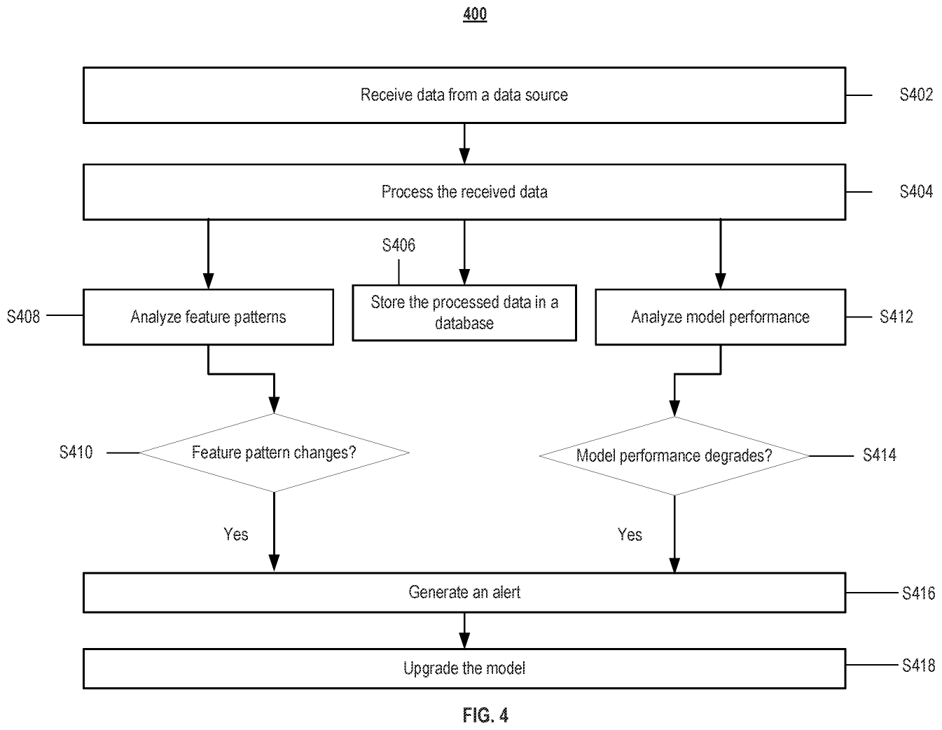

FIG. 4 is a flowchart of an exemplary method 400 for reviewing computer models, according to embodiments of the disclosure. Method 400 may be performed by model review device 130 and particularly processor 204 or a separate processor not shown in FIG. 2. However, method 400 is not limited to that exemplary embodiment. Method 400 may include steps S402-S418 as described below. It is to be appreciated that some of the steps may be optional to perform the disclosure provided herein. Further, some of the steps may be performed simultaneously, or in a different order than shown in FIG. 4.

In step S402, model review device 130 may be configured to communicate with a data source to receive the log data. For example, the data resource may be a storage, or a memory located inside prediction device 120. In some alternative embodiments, the data source may be a separate database associated with prediction device 120. In some embodiments, model review device 130 may be configured to receive the log data from more than one data sources. For example, information of the reported safety events and information of the safety prediction generated by the computer models are stored in different data sources.

In step S404, model review device 130 may be configured to process the received log data. Consistent with some embodiments, model review device 130 may extract features from the received data. The extracted features may include the information of the transportation services such as order information, driver information, and passenger information. The information of the transportation services may be used by the computer models to predict the reported safety events. The extracted features may further include the information of the reported safety event such as a crime type and an incident severity.

In some embodiments, dangerous signal determination unit 252 of model review device 130 may be configured to determine dangerous signals in the extracted information of the transportation services in step S404. The dangerous signals are associated with a high risk of safety event. For example, if the pickup location or the destination of the transportation service is in a list of predetermined points of interesting (e.g., night club, bar, and the like), the pickup location or the destination may be labeled as a dangerous signal. As another example, if the payment method is cash, the payment method of the transportation service may be labeled as another dangerous signal.

In some embodiments, risk index computing unit 254 of model review device 130 may be configured to compute a risk level or a risk percentile of the driver or the passenger using the computer models. For example, a driver risk prediction model may generate a risk score for the driver based on the information of the driver. In some embodiments, risk index computing unit 254 may determine a driver's risk level based on the generated driver risk score. For example, risk index computing unit 254 may determine the driver's risk level using a look-up table stored in storage 208. The look-up table may include 11 risk levels (e.g., from level 0 to level 10) matched with different risk scores. Level 0 may be assigned to a driver associated with a low-risk score, and level 10 may be assigned to a driver associated with a high-risk score. In some alternative embodiments, risk index computing unit 254 may determine the driver's risk level or the driver's risk percentile using a computer model based on the log data (e.g., the information of the driver). For example, a risk level or risk percentile of the driver may be determined using rule-based models or machine leaning models based on the features extracted from the information of the driver.

In step S406, model review device 130 may store the processed data into a database. For example, the database may be training database 101. Consistent with some embodiments, the processed data may be used for upgrading the computer models. In some embodiments, the processed data may be further used for generating a review report of a reported safety event. For example, the report may include the information of the reported safety event, the information of the transportation service during which the reported safety event occurs, the computer models used for predicting the reported safety events, and the safety prediction made by the computer models.

In step S408, model review device 130 may analyze feature patterns based on the processed data received from step S404. Consistent with some embodiments, model review device 130 may be configured to determine a data distribution based on the processed data (e.g., extracted features). In step S410, model review device 130 may further compare the determined data distribution with a data distribution generated based on the training data or a previous set of log data. If the two data distributions are different with each other, model review device 130 may generate an alert for upgrading the computer models in step S416.

In step S412, model review device 130 may analyze model performance based on the processed data received from step S404. Consistent with some embodiments, model review device 130 may be configured to determine the model performance based on the safety prediction of the computer models for the reported safety events. For example, model performance determination unit 244 may compare the safety prediction made by the computer models with the reported safety event. If the predicted safety events align with those actually reported safety events, the model performance is rated higher. In step S414, model review device 130 may further compare the determined model performance with a previous model performance that the computer models obtain based on a previous set of log data. If the determined model performance on predicting the reported safety events is lower than the previous model performance determined based on the previous set of log data, model review device 130 may generate an alert for upgrading the computer models in step S416. Consistent with the present disclosure, model review device 130 or model training device 102 may upgrade the computer models based on data including the transportation services associated with the reported safety events in step S418.

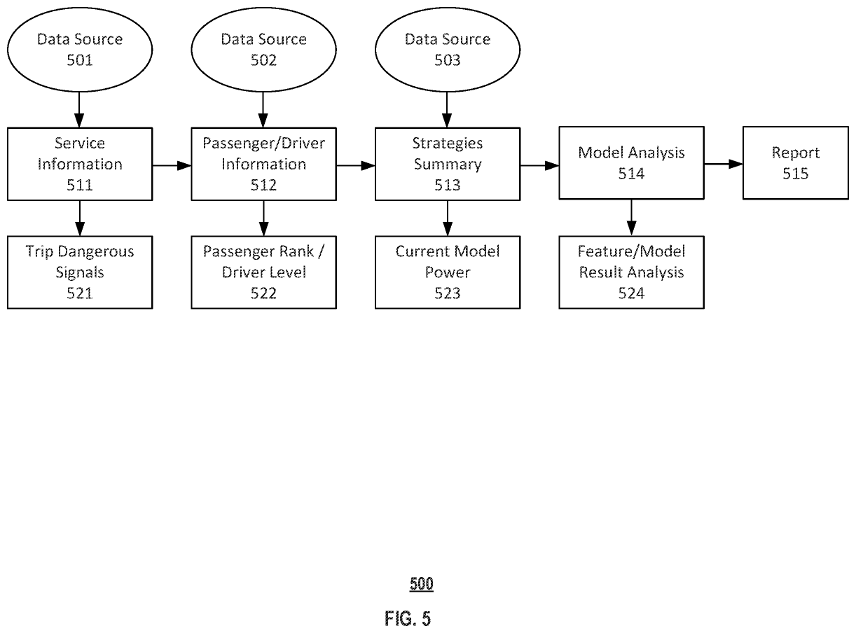

FIG. 5 illustrates a data flow diagram of an exemplary method 500 for generating a model review report for a reported safety event, according to embodiments of the disclosure. For example, a user may want to review information associated with an individual reported safety event. Consistent with some embodiments, the information may include the information of the transportation service (e.g., order information, driver information, and passenger information), the information of the reported safety event (e.g., a crime type, an incident severity, an incident ticket number, a victim of the incident, and the like), the safety prediction made by the computer models for predicting the reported safety event, etc.

As shown in FIG. 5, service information 511 may be extracted from a data source 501. For example, feature extraction unit 240 of model review device 130 may be configured to extract order information such as a pickup location and a destination from data source 501 (e.g., prediction device 120 or other databases). In some embodiments, dangerous signal determination unit 252 of model review device 130 may determine whether any data values of the transportation service associated with a high risk of safety events based on service information 511. The dangerous signals (e.g., trip dangerous signals 521) are predefined by model review device 130 based on the training data. For example, night clubs are frequently associated with safety events. Therefore, if the destination of the transportation service is a night club, the destination may be determined as a dangerous signal for the transportation service.

In some embodiments, model review device 130 may extract passenger information and driver information (e.g., passenger/driver information 512) from a data source 502. Data source 502 may be in a separate database or inside the same database as data source 501. In some embodiments, extraction unit 240 of model review device 130 may extract the data associated with the reported safety event from prediction device 120 or other databases. Consistent with some embodiments, risk index computing unit 254 of model review device 130 may be configured to compute a risk index (e.g., passenger rank/driver level 522) of the passenger or the driver based on passenger/driver information 512.

In some embodiments, model review device 130 may extract safety prediction result made by the computer models (e.g., strategies summary 513) from a data source 503. Data source 503 may be in a separate database or inside the same database as data source 501 or data source 502. In some embodiments, a strategies summary 513 may include the computer models designed for predicting a specific safety event. For example, if the reported safety event is a sexual assault case, model review device 130 may extract safety prediction results made by the computer models which are designed for predicting sexual assaults based on the information of the transportation service. In some embodiments, model review device 130 may determine current model power 523 (an exemplary indicator of model performance) based on comparing the safety prediction (e.g., a risk index of the transportation service) with the reported safety event. For example, if the reported safety event is correctly predicted by the model, the model may have a high model power for the reported safety event.

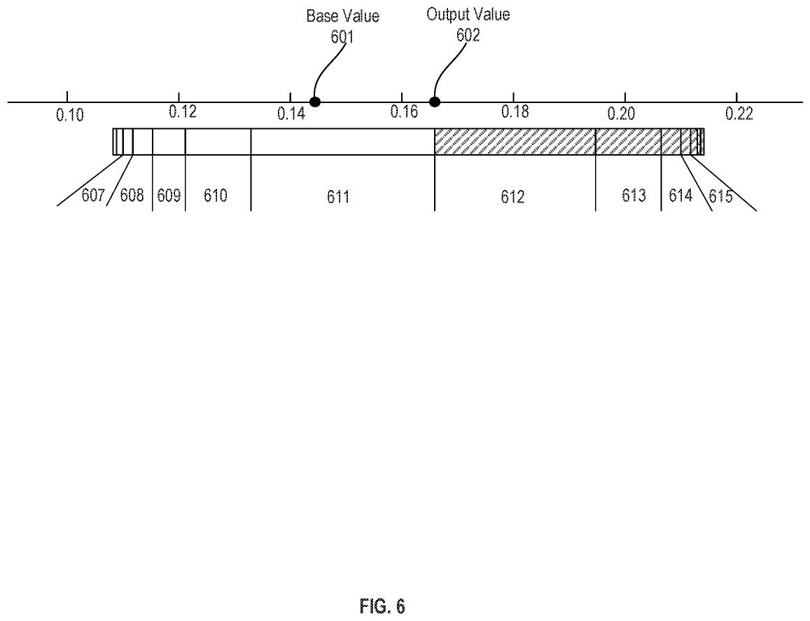

In some embodiments, model review device 130 may further generate model analysis 514 by analyzing relationship between input features and an output prediction based on the extracted data from data sources 501-503. For example, FIG. 6 illustrates an exemplary plot for displaying feature impacts on a safety prediction, according to embodiments of the disclosure. As shown in FIG. 6, base value 601 is a safety prediction index obtained by applying a risk prediction model on a transportation service with all features being default values. Output value 602 is a safety prediction index obtained by applying the risk prediction model on a transportation service with displayed feature values (e.g., feature values 607-615). In some embodiments, feature values 607-615 may include a feature name (e.g., remoteness score of the destination) and the corresponding value (e.g., 0.3). As shown in FIG. 6, feature values 612-615 (illustrated in dashed bars) positively impact output value 602, e.g., the presence of those features making output value 602 larger. Feature values 612-615 are displayed in an order based on their degrees of impact on output value 602. For example, from left to right, feature value 612 has the largest positive impact on output value 602 and feature value 613 has the second largest positive impact on output value 602. Similarly, feature values 607-611 (illustrated in solid bars) negatively impact output value 602. The length of each bar is proportional to the degree of impact of the corresponding feature value on output value 602.

Returning to FIG. 5, feature/model result analysis 524 may include the plot displaying the relationship between the input features and the output prediction as shown in FIG. 6. In some embodiments, feature/model result analysis 524 may further include a risk index of the transportation service computed by model review device 130 using the computer models. In some embodiments, risk index computing unit 254 may be configured to compute the risk index based on the information of the transportation service. The risk index may be indicative of a risk of crime that may occur during the transportation service. For example, the risk index can be a numeric value between 0 and 1. A smaller value indicates a lower risk of crime, and a larger value indicates a higher risk of crime during the transportation service.

In some embodiments, model review device 130 may generate a report (e.g., report 515) based on trip dangerous signals 521, passenger rank/driver level 522, current model power 523, and feature/model result analysis 524. Report 515 may further include service information 511, passenger/driver information 512, strategies summary 513, and model analysis 514. For example, report 515 may include the information of the reported safety event such as the ticket number, the crime type, and the victim. Report 515 may further include the service information (e.g., a service number, the pickup location, and the destination) and the dangerous signals in the service information. The passenger rank and the driver level may be included with the passenger information and the driver information, respectively. Report 515 may also include model power information such as a quantity of successfully predicted safety events by the computer models. Report 515 may additionally include a feature impact plot and a risk index of the transportation service.

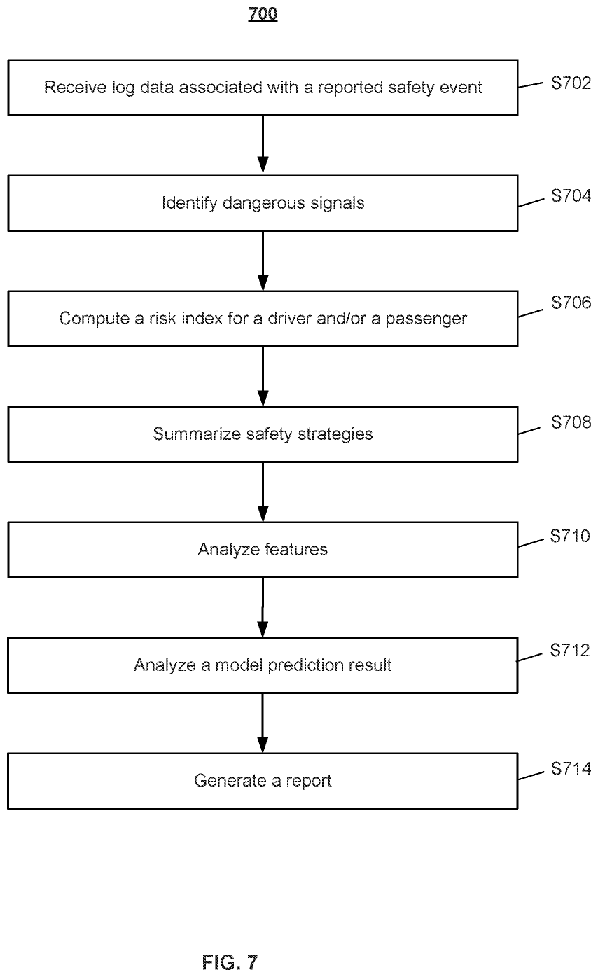

FIG. 7 is a flowchart of an exemplary method 700 for generating a model review report for a reported safety event, according to embodiments of the disclosure. In step S702, model review device 130 may be configured to receive log data associated with a transportation service during which a reported safety event occurs. Consistent with the present disclosure, the log data may include information of the transportation service, information of the reported safety event, and information of the computer models used for predicting the reported safety event.

In step S704, model review device 130 may be configured to identify dangerous signals in the information of the transportation service. For example, the information of the transportation service includes cancellation rates of the passenger. A high cancellation rate is associated with a high risk of safety event. In one example, if a cancellation rate of the passenger associated with the transportation service is 0.9 and an average value of the cancellation rate for all registered passengers is 0.5, the cancellation rate of the passenger may be identified as a dangerous signal for having a safety event.

In step S706, model review device 130 may be configured to compute a risk index for the driver or the passenger associated with the transportation service. Consistent with some embodiments, model review device 130 may generate the risk index (e.g., a passenger rank, a driver level, or the like) using computer models based on the log data. For example, a driver level may be computed using a driver risk prediction model based on driver information (e.g., a quantity of completed orders by the driver, a cancellation rate of the driver, and the like). A passenger rank may be computed using a passenger risk prediction model based on passenger information (e.g., a passenger income percentile, a quantity of completed orders by the passenger, a cancellation rate of the passenger, and the like).

In step S708, model review device 130 may be configured to summarize safety strategies applied on the log data. The safety strategies may include multiple computer models for predicting safety events. For example, the safety strategies may include a geo-location analysis model which may generate a remoteness score for a given location (e.g., the pickup location or the destination). The remoteness scores may be used for predicting a risk index of the transportation service. As another example, the safety strategies may further include a relationship graph model which may analyze the relationship among multiple user accounts registered using a same contact method (e.g., phone number). Consistent with some embodiments, model review device 130 may extract safety predictions made by the computer models in the safety strategies for reviewing the model performance.

In step S710, model review device 130 may be configured to analyze features that the computer models use to generate a safety prediction. For example, model review device 130 may sort the features by their impact degrees on the safety prediction (e.g., output value 602) and generate a feature impact plot as shown in FIG. 6. In step S712, model review device 130 may be configured to analyze a model prediction result by computing a risk index of the transportation service (e.g., a trip risk level or a trip risk percentile) using the computer models. A large risk index (e.g., larger than a predetermined value such as an average value) indicates a high safety risk associated with the transportation service.

In step S714, model review device 130 may generate a report including information generated in steps S704-S712. For example, the report (e.g., report 515) may include the information of the reported safety event, the information of the transportation service, the safety prediction of the computer models, the identified dangerous signals, the computed risk indexes of the driver and/or the passenger, the summarized safety strategies, the feature impact plot, the risk index of the transportation service, etc.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A system for reviewing performance of computer models for safety analysis in transportation services, comprising:
a communication interface configured to receive log data associated with at least one reported safety event, wherein the log data includes information of the reported safety event, a transportation service during which the reported safety event occurs, and one or more computer models used for predicting the reported safety event, wherein the one or more computer models are associated with a first feature pattern and a first model performance; and
at least one processor, configured to:
extract a plurality of features from the log data that are used by the computer models to make a safety prediction;
determine a second feature pattern indicative of respective impacts of the features on the safety prediction result made by the computer models;
determine a second model performance of the computer models based on the safety prediction made by the computer models compared with the reported safety event;
detect a change in feature pattern based on the first feature pattern and the second feature pattern or a performance degradation based on the first model performance and the second model performance; and
generate an alert to upgrade the computer models.

2. The system of claim 1, wherein the information of the transportation service comprises order data, driver data, and passenger data, wherein the at least processor is further configured to determine dangerous signals from the information of transportation service that is associated with a high risk of safety event.

3. The system of claim 1, wherein the at least one processor is further configured to compute a risk index indicative of a risk level or a risk percentile of the driver or the passenger using the computer models based on the log data.

4. The system of claim 1, wherein to determine the second model performance, the at least one processor is further configured to compute a risk index indicative of a risk level or a risk percentile of the transportation service using the computer models.

5. The system of claim 1, wherein the computer models comprise a machine learning model and a rule-based model.

6. The system of claim 1, wherein the at least one processor is further configured to when the alert to upgrade the computer models is generated, update model parameters of the machine learning model by training the machine learning model based on training data including the log data.

7. The system of claim 1, wherein the at least one processor is further configured to:
generate a plot of the second feature pattern, wherein the plot distinguishably displays a first subset of features that positively impact the safety prediction and a second subset of features that negatively impact the safety prediction.

8. The system of claim 1, wherein the change of feature pattern is detected when the impact of at least one feature changes between the first feature pattern and the second feature pattern.

9. The system of claim 1, wherein the performance degradation is detected when the second model performance is lower than the first model performance.

10. A method for reviewing performance of computer models for safety analysis in transportation services, comprising:
receiving, by a communication interface, log data associated with at least one reported safety event, wherein the log data includes information of the reported safety event, a transportation service during which the reported safety event occurs, and one or more computer models used for predicting the reported safety event, wherein the one or more computer models are associated with a first feature pattern and a first model performance;
extracting, by at least one processor, a plurality of features from the log data that are used by the computer models to make a safety prediction;
determining, by the at least one processor, a second feature pattern indicative of respective impacts of the features on the safety prediction result made by the computer models;
determining, by the at least one processor, a second model performance of the computer models based on the safety prediction made by the computer models compared with the reported safety event;
detecting a change in feature pattern based on the first feature pattern and the second feature pattern or a performance degradation based on the first model performance and the second model performance; and
generating, by the at least one processor, an alert to upgrade the computer models.

11. The method of claim 10, further comprising:
determining, by the at least one processor, dangerous signals from the information of transportation service that is associated with a high risk of safety event, wherein the information of the transportation service comprises order data, driver data, and passenger data.

12. The method of claim 10, further comprising:
computing, by the at least one processor, a risk index indicative of a risk level or a risk percentile of the driver or the passenger using the computer models based on the log data.

13. The method of claim 10, wherein determining the second model performance further comprises:
computing a risk index indicative of a risk level or a risk percentile of the transportation service using the computer models.

14. The method of claim 10, wherein the computer models comprise a machine learning model and a rule-based model.

15. The method of claim 10, further comprising:
when the alert to upgrade the computer models is generated, updating, by the at least one processor, model parameters of the machine learning model by training the machine learning model based on training data including the log data.

16. The method of claim 10, further comprising:
generating a plot of the second feature pattern, wherein the plot distinguishably displays a first subset of features that positively impact the safety prediction and a second subset of features that negatively impact the safety prediction.

17. The method of claim 10, wherein the change of feature pattern is detected when the impact of at least one feature changes between the first feature pattern and the second feature pattern.

18. The method of claim 10, wherein the performance degradation is detected when the second model performance is lower than the first model performance.

19. A non-transitory computer-readable medium having a computer program stored thereon, wherein the computer program, when executed by at least one processor, performs a method for reviewing performance of computer models for safety analysis in transportation services, the method comprising:
receiving log data associated with at least one reported safety event, wherein the log data includes information of the reported safety event, a transportation service during which the reported safety event occurs, and one or more computer models used for predicting the reported safety event, wherein the one or more computer models are associated with a first feature pattern and a first model performance;
extracting a plurality of features from the log data that are used by the computer models to make a safety prediction;
determining a second feature pattern indicative of respective impacts of the features on the safety prediction result made by the computer models;
determining a second model performance of the computer models based on the safety prediction made by the computer models compared with the reported safety event;
detecting a change in feature pattern based on the first feature pattern and the second feature pattern or a performance degradation based on the first model performance and the second model performance; and
generating an alert to upgrade the computer models.

20. The method of claim 19, further comprising:
determining dangerous signals from the information of transportation service that is associated with a high risk of safety event, wherein the information of the transportation service comprises order data, driver data, and passenger data.
